(19) United States
(12) Patent Application Publication
(10) Pub. No.: US 2005/0111385 A1
(43) Pub. Date: May 26, 2005

(54) Multimedia communication device using software and hardware protocol stacks and communication method thereof

(75) Inventor: Hyun-seok Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/993,349

(22) Filed: Nov. 22, 2004

(30) Foreign Application Priority Data
Nov. 24, 2003 (KR) 2003-83621

(51) Int. Cl. H04L 12/28

(52) U.S. Cl. 370/254

(57) ABSTRACT

A multimedia communication device using a software protocol stack and a hardware protocol stack, a communication method thereof, and a computer program product are provided. The multimedia communication device includes: a hardware protocol stack processing a packet using hardware; and a software protocol stack processing the packet using software. According to the device and method, while the overhead to the CPU can be reduced to enhance the processing speed, a large volume of multimedia data can be transmitted at a higher speed without a limit to the number of channels that can be supported at the same time.

### BACKGROUND OF THE INVENTION

This application claims the priority of Korean Patent Application No. 2003-83621, filed on Nov. 24, 2003, in the Korean Intellectual Property Office, the disclosure of which is incorporated herein in its entirety by reference.

1. Field of the Invention

The present invention relates to a multimedia communication device using transport control protocol/Internet protocol (TCP/IP), and more particularly, to a multimedia communication device using a software protocol stack and a hardware protocol stack, and a communication method thereof.

2. Description of the Related Art

TCP/IP is a standard protocol providing Internet communication of computers, and is formed with multiple layers as are other network protocols. These layers are referred to as a protocol stack, a protocol suite, or a protocol structure.

More specifically, the protocol stack is based on two most important protocols, transport control protocol/user datagram protocol (TCP/UDP) and Internet protocol (IP). TCP/UDP protocol is used to transmit data in units of packets, and each packet has a header storing control information. This header includes a port number capable of distinguishing application protocols such as hypertext transfer protocol (HTTP), simple mail transfer protocol (SMTP), file transfer protocol (FTP), network virtual terminal protocol (TELNET), and this port number is used by a destination system to determine an application to process the corresponding packet. TCP/UDP protocol is also referred to as layer 4 protocol.

Meanwhile, IP protocol provides functions to connect physical sub-networks and select a route to a destination IP address. For this, IP protocol assigns and interprets source and destination addresses of a number of terminals or nodes connected to the Internet. At present, IP version 4 (IPv4) is mainly used. IP protocol is also referred to as layer 3 protocol.

TCP/IP protocol stack is connected media access control (MAC) layer in the layer 2, or physical layer (PHY) in the layer 1 as a lower layer, and connected to application layer as an upper layer.

TCP/IP protocol stack is usually implemented by software, which will be referred to as a software protocol stack hereinafter. FIG. 1 is a diagram showing TCP/IP overhead when a software protocol stack is used.

Referring to FIG. 1, overhead for processing the software protocol stack for each maximum transfer unit (MTU) is shown, and it can be seen that in order to process TCP/IP protocol, a lot of overhead occurs for operations such as interrupt, checksum, or memory copy. In particular, when a large volume of multimedia data are transmitted at a higher speed, and only the software protocol stack is used, there are problems that the processing overhead to the CPU increases greatly, and the entire processing speed of the system is lowered.

Meanwhile, in order to transmit multimedia data in real time at a higher speed, a dedicated hardware protocol stack (chip) can also be used. However, a system using the hardware protocol stack has a disadvantage in that there is a limit in the number of channels for the Internet connection. Dedicated Internet protocol chips recently sold in the market support usually 2 to 4 simultaneous connection channels. However, generally in ordinary computer systems, a variety of Internet application programs use multiple channels at the same time. Accordingly, when only the hardware protocol stack is used, the number of Internet application programs that can be executed at the same time is limited to only one or two programs.

### SUMMARY OF THE INVENTION

An aspect of the present invention provides a multimedia communication device using a software protocol stack and a hardware protocol stack, and a communication method thereof.

That is, while reducing the overhead to the CPU to enhance the processing speed, an aspect of the present invention can transmit a large volume of multimedia data at a higher speed without a limit to the number of channels supported at the same time.

According to an aspect of the present invention, there is provided a multimedia communication device including: a hardware protocol stack processing a packet using hardware; and a software protocol stack processing the packet using software; and a socket comparison and selection unit which selects one of the software protocol stack and the hardware protocol stack according to the sort of packet processed and transmits the packet to a selected protocol stack.

The socket comparison and selection unit may extract a socket pair including a port number addressing an application socket from the packet, compare the socket pair with a predetermined socket pair for the hardware protocol stack, and if the socket pairs match, transmit the packet to the hardware protocol stack, or else transmit the packet to the software protocol stack.

The multimedia communication device may further include: a socket pair register which stores the predetermined socket pair of the hardware protocol stack so that multimedia data requiring high capacity and/or high speed data transmission are transmitted to the hardware protocol stack.

The multimedia communication device may further include: an arbitration unit which designates transmission priorities of packets received from the hardware protocol stack and the software protocol stack to prevent collision between the software protocol stack and the hardware protocol stack.

According to another aspect of the present invention, there is provided a multimedia apparatus including the multimedia communication device.

The multimedia apparatus may be any one of a digital television, a mobile apparatus, a digital versatile disc (DVD) reproduction, reproducing apparatus, and a multimedia server.

According to still another aspect of the present invention, there is provided a multimedia communication method including: extracting a socket pair from a transferred packet, and determining whether the socket pair matches a predetermined socket pair for a hardware protocol stack; if both match, transmitting the packet to the hardware protocol stack; and if both do not match, transmitting the packet to a software protocol stack.

The predetermined socket pair for the hardware protocol stack may be a socket pair of a hardware protocol stack which processes multimedia data requiring high capacity and/or high speed data transmission.

According to yet another aspect of the present invention, there is provided a computer program product for enabling a computer to implement operations for performing a multimedia communication method, the computer program product including a computer readable medium and instructions on the computer readable medium, the operations including: extracting a socket pair from a transferred packet, and determining whether the socket pair matches a predetermined socket pair for a hardware protocol stack; if the extracted socket pair and the predetermined socket pair match, transmitting the packet to the hardware protocol stack; and, if the extracted socket pair and the predetermined socket pair do not match, transmitting the packet to a software protocol stack.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram showing transport control protocol/Internet protocol (TCP/IP) overhead when a software protocol stack is used;

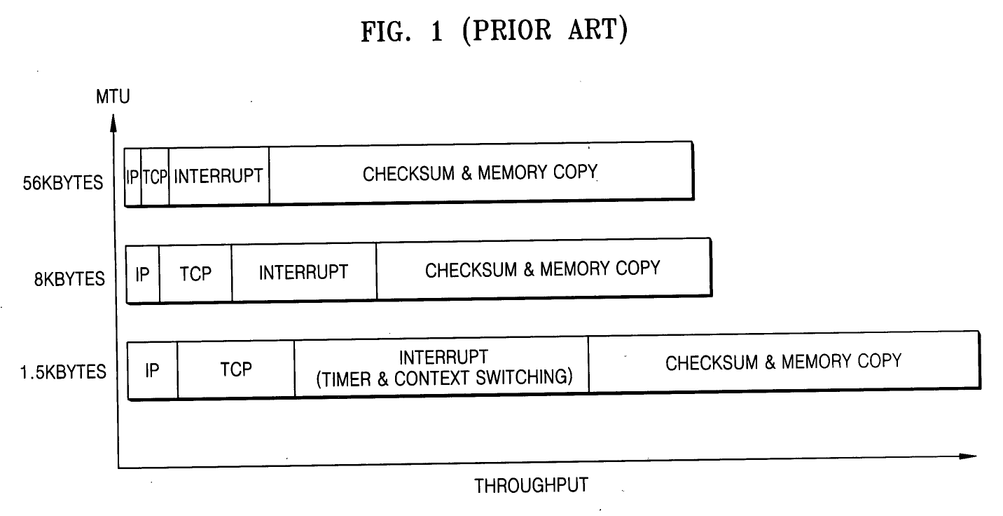

FIG. 2 is a diagram of an example of a system to which a multimedia communication device according to a preferred embodiment of the present invention is applied;

FIG. 3 is a block diagram of hierarchical layers of a multimedia communication device according to an exemplary embodiment of the present invention;

FIG. 4 is a diagram explaining the interoperation relation between a software protocol stack and a hardware protocol stack of the multimedia communication device shown in FIG. 3;

FIG. 5 is a block diagram of a multimedia communication device to implement the interoperation relation between a software protocol stack and a hardware protocol stack;

FIG. 6 is a diagram explaining the structure of a socket pair compared by a socket comparison selection unit shown in FIG. 5;

FIGS. 7A and 7B show schematic diagrams of examples implementing a multimedia communication device according to the present invention; and

FIG. 8 is a flowchart of the steps performed by a multimedia communication method according to the present invention;

### DETAILED DESCRIPTION OF EXEMPLARY EMBODIMENTS

The present invention will now be described more fully with reference to the accompanying drawings, in which exemplary embodiments of the invention are shown.

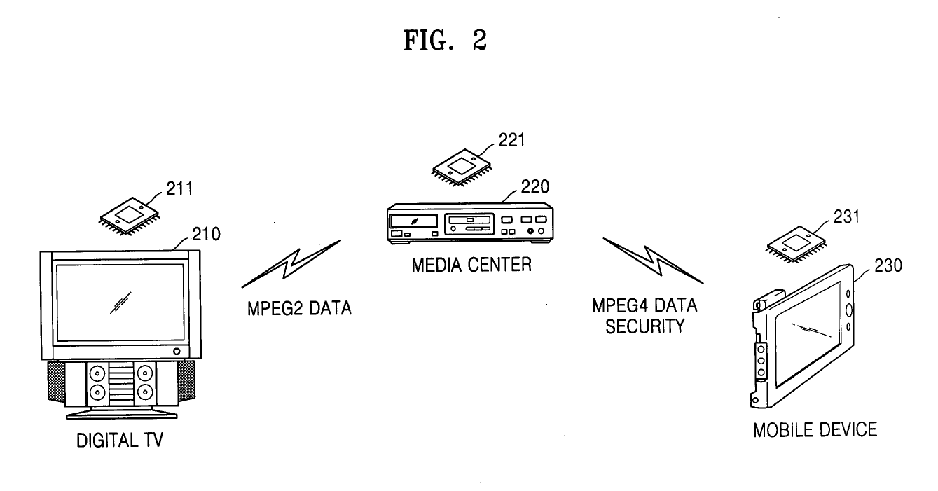

Referring to FIG. 2, a digital TV 210 or a mobile apparatus 230 can receive and reproduce a large volume of multimedia data through a multimedia server 220. A multimedia communication device 211, 221, and 231 using a software protocol stack and a hardware protocol stack according to the present invention is included in each apparatus.

By using the multimedia communication device according to the present invention, the digital TV 210 or mobile apparatus 230 can use the hardware protocol stack when it transmits a large volume of high speed multimedia data, and use the software protocol stack when it transmits a small volume of data other than the multimedia data, such as control data for multimedia data, or ordinary Internet application programs.

Accordingly, when a large volume of multimedia data are transmitted, by using the hardware protocol stack, decrease in processing speed can be prevented, and when a small volume of other data are transmitted, by using the software protocol stack, the communication can be performed smoothly without any limit to the number of channels.

The multimedia server 220, digital TV 210, and the mobile apparatus 230 shown in FIG. 2 are only examples to which the multimedia communication device of the present invention is applied. The present invention can be applied to a DVD reproduction recording apparatus, a computer, and the like, in a variety of ways and with modifications.

The structure of the multimedia communication device according to the present invention will now be explained in more detail.

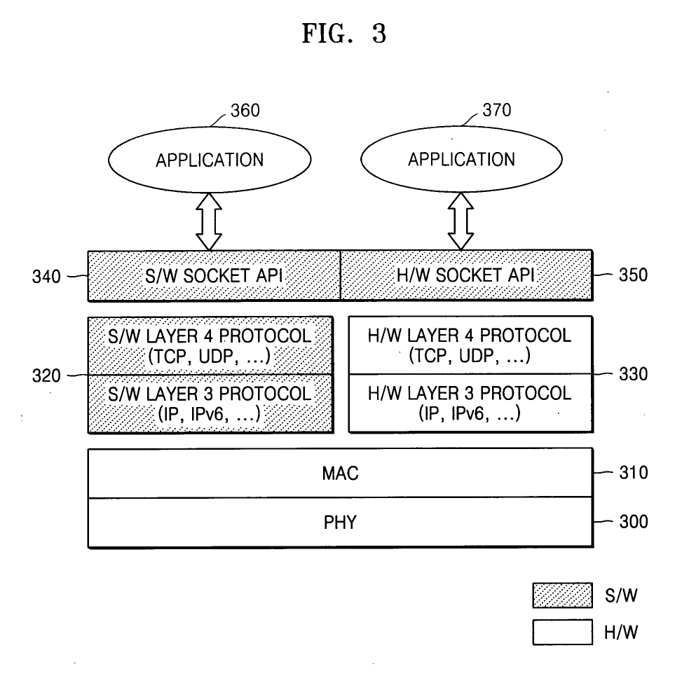

FIG. 3 is a block diagram of hierarchical layers of a multimedia communication device according to an exemplary embodiment of the present invention.

Referring to FIG. 3, the multimedia communication device according to the exemplary embodiment includes a software protocol stack 320 and a hardware protocol stack 330.

The software protocol stack 320 is formed with the layer 4 protocol stack, such as TCP or UDP, and the layer 3 protocol stack such as IP or IPv6, as described above. A packet which is transferred to the software protocol stack 320 through the layer 1 PHY stack 300 and the layer 2 MAC stack 310 is parsed, and is transferred to an application program 360 corresponding to the packet through a software socket application program interface (API) 340.

The hardware protocol stack 330 is also formed with the layer 4 protocol stack, such as TCP or UDP, and the layer 3 protocol stack such as IP or IPv6, as described above. A packet which is transferred to the hardware protocol stack 330 through the layer 1 PHY stack 300 and the layer 2 MAC stack 310 is parsed, and is transferred to an application program 370 corresponding to the packet through a hardware socket API 350.

Here, the application program 370 connected to the hardware protocol stack 330 will be usually an application program processing a large volume of data such as multimedia data, and the application program 360 connected to the software protocol stack 320 will be usually an application program processing a small volume of other data.

The structure in which it is determined through which stack between the hardware protocol stack 330 and the software protocol stack 320, the packet transferred through the MAC/PHY stacks 310 and 300 should be processed, will now be explained.

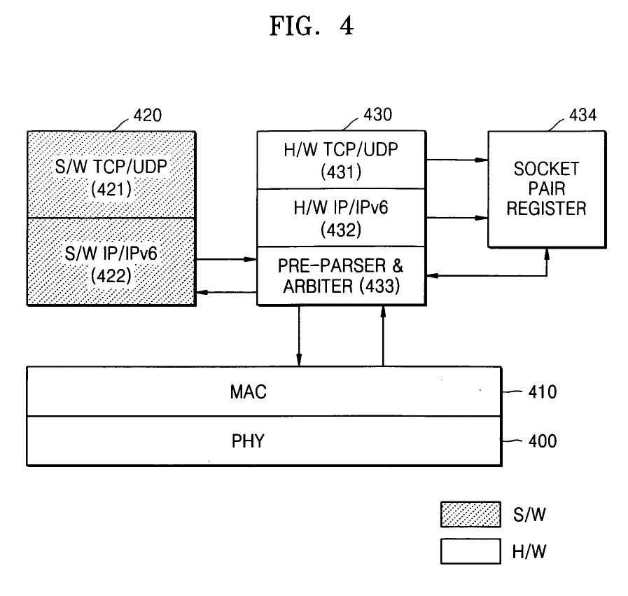

FIG. 4 is a diagram explaining the interoperation relation between the software protocol stack and the hardware protocol stack of the multimedia communication device shown in FIG. 3.

Referring to FIG. 4, the packet transferred through the MAC/PHY stacks 410 and 400 is first transferred to the hardware protocol stack 430. In addition to the layer 4 protocol stack, such as TCP or UDP, and the layer 3 protocol stack such as IP or IPv6, the hardware protocol stack 430 further includes a socket comparison and selection unit/arbitration unit (PREPARSER & ARBITER) 433 and a socket pair register 434.

The socket comparison and selection unit/arbitration unit (PREPARSER & ARBITER) 433 preparses a packet transferred through the MAC/PHY stacks 410 and 400, extracts a socket pair, and then, compares it with a predetermined socket pair stored in the socket pair register 434. If the comparison result indicates that it matches the predetermined socket pair, the packet is transferred to the hardware protocol stack 430, or else it is transferred to the software protocol stack 420.

The socket pair register 434 stores a socket pair for multimedia data requiring a large volume/high speed transmission, in advance. A socket pair extracted from the transferred packet is compared with the predetermined socket pair stored in the socket pair register 434.

According to this, multimedia data requiring a large volume/high speed transmission are transferred to the hardware protocol stack and other data are transferred to the software protocol stack, and then processed.

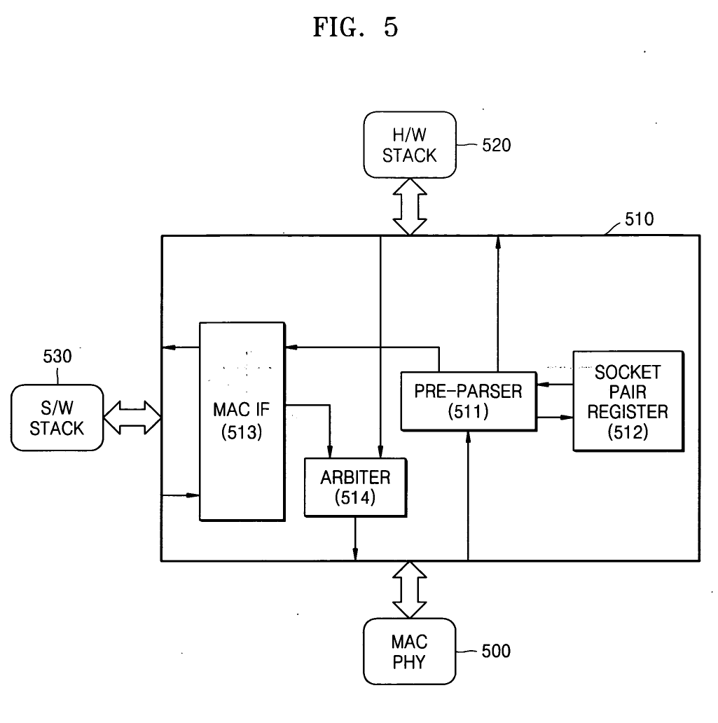

FIG. 5 is a block diagram of a multimedia communication device to implement the interoperation relation between a software protocol stack and a hardware protocol stack.

Referring to FIG. 5, a packet is transferred first to a comparison selection unit (PREPARSER) 511 through MAC/PHY stacks 500. The comparison selection unit (PREPARSER) 511 parses the received packet, extracts a socket pair, compares it with a socket pair for a hardware protocol stack, which is defined in advance and stored in the socket pair register 512. If the comparison result indicates that the pairs match, the packet is transferred to a hardware protocol stack 520 and processed by the TCP/IP protocol. If the pairs do not match, the packet is transferred to a software protocol stack 530 through a MAC interface 513, and processed by the TCP/IP protocol.

Meanwhile, in order to prevent collision between the software protocol stack and the hardware protocol stack, an arbitration unit (ARBITER) 514 decides priorities of packets to be transmitted to the outside through the MAC/PHY stack 500 from any one of the software protocol stack and the hardware protocol stack, and transmits the packets according to the priorities. The priority of a packet may be determined by a first-in-first-out (FIFO) method, or a round-robin method. It can also be arbitrated by any other algorithm.

Accordingly, the packet transferred to the hardware protocol stack 520 by the socket comparison selection unit (PREPARSER) 511 can be processed at a higher speed such that the efficiency of transmission of a large volume of data such as multimedia data can be enhanced.

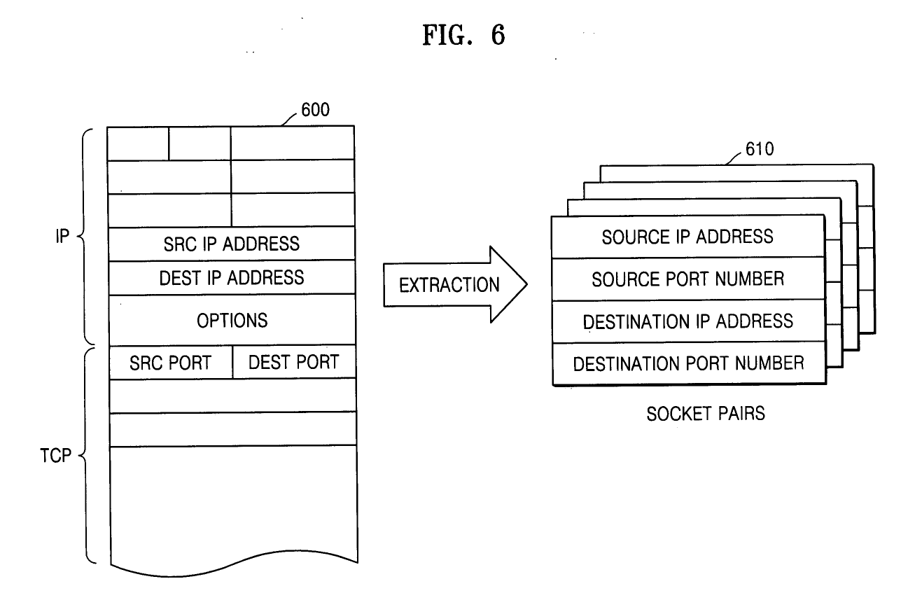

FIG. 6 is a diagram explaining the structure of a socket pair compared by a socket comparison selection unit (PREPARSER) 511 shown in FIG. 5.

Referring to FIG. 6, the structure of a packet 600 is shown on the left hand side, and a socket pair 610 extracted from the packet is shown on the right hand side.

First, in the structure of the packet 600, IP or IPv6 protocol includes a source IP address and a destination IP address, and TCP or UDP protocol includes a port number capable of distinguishing an application program such as hypertext transfer protocol (HTTP), simple mail transfer protocol (SMTP), file transfer protocol (FTP), network virtual terminal protocol (TELNET), in the header of each packet. This port number is used to determine an application socket to process the corresponding packet in a destination system. The port number can have a value between 1 and 255 inclusive, which is determined for a predetermined application. A standard UNIX service has a value between 256 and 1024 inclusive, and a user application uses a value equal to or greater than 1025. For example, numbers are predetermined as 80 for HTTP, 20 for FTP data, 21 for FTP control, 23 for TELNET, and 25 for SMTP, and a user application can use an arbitrary value equal to or greater than 1025.

The socket pair 610 used to address an application which a packet is transferred to and processed by is generated by extracting the source IP address (SRC IP ADDRESS), destination IP address (DEST IP ADDRESS), source port number (SRC PORT NUMBER), and destination port number (DEST PORT NUMBER) of the packet. Through this socket pair 610, the address of a destination node to which the packet is to be transferred and an application program which is to use the packet can be assigned.

The multimedia communication device according to the present invention extracts the socket pair 610 from the received packet 600, and compares it with a predetermined socket pair for the hardware protocol stack 520 in the socket pair register 512. If the comparison result indicates that the pairs match, the corresponding packet 600 is transferred to the hardware protocol stack 520 and processed. If the pairs do not match, the corresponding packet 600 is transferred to the software protocol stack 530 and processed.

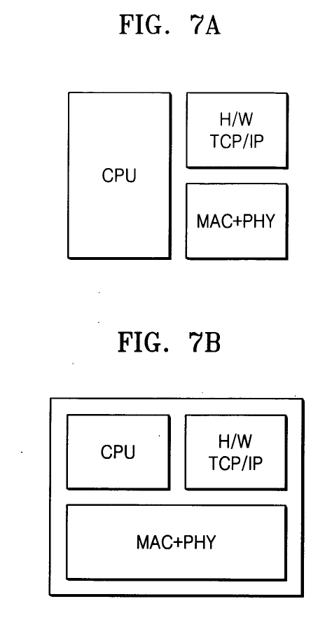

FIGS. 7A and 7B show schematic diagrams of examples implementing a multimedia communication device according to the present invention.

Referring to FIG. 7A, an example of the multimedia communication device according to the embodiment described above, implemented as a plurality of chips having respective functions, is shown. That is, the device can be implemented in the form of a plurality of chips performing respective functions, embedded in a communication card such as an Ethernet card. CPU performs the function of the software protocol stack described above, hardware TCP/IP performs the function of the hardware protocol stack described above, and MAC+PHY performs the function of the MAC/PHY stack. The example of FIG. 7A is just one embodiment implemented by a plurality of blocks, and the present invention can be implemented in a variety of ways.

Referring to FIG. 7B, an example of the multimedia communication device according to the embodiment described above, implemented as one system-on-chip (SoC) integrating respective function into a single chip, is shown.

That is, the CPU, hardware TCP/IP, and MAC+PHY functions described above are implemented in one chip.

Based on the structure of the multimedia communication device described above, a multimedia communication method will now be explained.

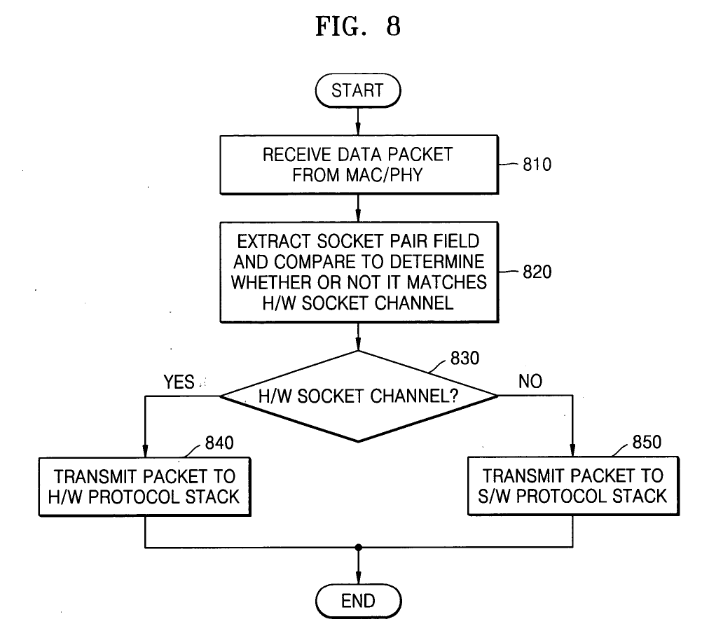

FIG. 8 is a flowchart of the steps performed by a multimedia communication method according to an embodiment of the present invention.

Referring to FIG. 8, for multimedia communication using a software protocol stack and a hardware protocol stack, first, a data packet is received from MAC/PHY stack in step 810. A socket pair is extracted from the received packet and is compared to determine whether or not it is a hardware socket channel in step 820. If the comparison result indicates that it matches the hardware socket channel in step 830, the packet is transmitted to the hardware protocol stack in step 840, or else, the packet is transmitted to the software protocol stack in step 850. The packet transmitted to each stack is processed such that multimedia data or ordinary Internet data are transmitted.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

According to the embodiments of the present invention as described above, a multimedia communication device using a software protocol stack and a hardware protocol stack, and a communication method thereof are provided. That is, while reducing the overhead to the CPU to enhance the processing speed, the present invention can transmit a large volume of multimedia data at a higher speed without a limit to the number of channels supported at the same time.

1. A multimedia communication device comprising:
a hardware protocol stack processing a packet using hardware;
a software protocol stack processing the packet using software; and
a socket comparison and selection unit which selects one of the software protocol stack and the hardware protocol stack according to a type of packet processed and transmits the packet to the selected protocol stack.

2. The multimedia communication device of claim 1, wherein the socket comparison and selection unit extracts a socket pair including a port number addressing an application socket from the packet, compares the socket pair with a predetermined socket pair for the hardware protocol stack, and if the socket pairs match, transmits the packet to the hardware protocol stack, or else transmits the packet to the software protocol stack.

3. The multimedia communication device of claim 2, further comprising:
a socket pair register which stores the predetermined socket pair of the hardware protocol stack so that multimedia data requiring high capacity and/or high speed data transmission are transmitted to the hardware protocol stack.

4. The multimedia communication device of claim 1, further comprising:
an arbitration unit which designates transmission priorities of packets received from the hardware protocol stack to prevent collision between the software protocol stack and the hardware protocol stack.

5. A multimedia apparatus comprising the multimedia communication device of claim 1.

6. The multimedia apparatus of claim 5, wherein the multimedia apparatus is any one of a digital television, a mobile apparatus, a digital versatile disc (DVD) reproduction, recording apparatus, and a multimedia server.

7. A multimedia communication method comprising:
extracting a socket pair from a transferred packet, and determining whether the socket pair matches a predetermined socket pair for a hardware protocol stack;
if it is determined that the extracted socket pair and the predetermined socket pair match, transmitting the packet to the hardware protocol stack; and
if it is determined that the extracted socket pair and the predetermined socket pair do not match, transmitting the packet to a software protocol stack.

8. The multimedia communication method of claim 7, wherein the predetermined socket pair for the hardware protocol stack is a socket pair of a hardware protocol stack which processes multimedia data requiring high capacity and/or high speed data transmission.

9. A computer program product for enabling a computer to implement operations for performing a multimedia communication method, the computer program product comprising a computer readable medium and instructions on the computer readable medium, the operations comprising:
extracting a socket pair from a transferred packet, and determining whether the socket pair matches a predetermined socket pair for a hardware protocol stack;
if the extracted socket pair and the predetermined socket pair match, transmitting the packet to the hardware protocol stack; and
if the extracted socket pair and the predetermined socket pair do not match, transmitting the packet to a software protocol stack.

10. The computer program product of claim 9, wherein the predetermined socket pair for the hardware protocol stack is a socket pair of a hardware protocol stack which processes multimedia data requiring high capacity and/or high speed data transmission.
